(19) United States
(12) Patent Application Publication
(10) Pub. No.: US 2012/0035887 A1
(43) Pub. Date: Feb. 9, 2012

(54) SHADING ANALYSIS SOFTWARE

(76) Inventors: Joseph Augenbraun, Foster City, CA (US); Kevin Cammack, Palo Alto, CA (US); Devon K. Johnson, San Carlos, CA (US); Jialin Sun, Fremont, CA (US); Allard C. Chu, Hercules, CA (US)

(21) Appl. No.: 12/849,755

(22) Filed: Aug. 3, 2010

(51) Int. Cl. G06F 17/50

(52) U.S. Cl. 703/1

(57) ABSTRACT

Systems and methods for shading analysis and creating a 3D model of a surface of interest are provided. Such systems and methods may include taking ray traces to determine light contact with the surface of interest. Shadow maps may be generated. Power flux calculations may also be performed.

### BACKGROUND OF THE INVENTION

1. Field of the Invention

The present invention relates generally to the field of solar energy. More specifically, various embodiments of the invention provide a process to collect data and analyze the light that falls on a surface of interest.

2. Description of Related Art

There is a widespread concern that future energy supplies from coal, gas and oil may be volatile and unreliable and that these energy sources are sources of greenhouse gasses which may have detrimental environmental impact. Demand for energy from non-polluting, renewable sources, such as solar energy, is rapidly growing. The widespread deployment of solar energy systems in the near-term is therefore highly desirable. However, the high cost of deploying solar energy systems, particularly on rooftops and for small, distributed generation, is a significant barrier to end-user acceptance and to overall dissemination.

Solar energy systems require analysis of shading and power flux to optimize solar energy system placement and to accurately predict energy output. Current data collection methods may include physical testing and surveying obstructions from multiple points on the proposed installation area. This method requires a physical presence at the proposed installation site and specialized equipment, as well as being time-consuming. Because the data collection process must be performed for every proposed solar energy system installation to determine ultimate energy yield, the cost of this data collection adds a significant labor cost to solar energy system deployment costs. Lowering these costs removes a meaningful barrier to the deployment of solar energy systems by making it more affordable for end users and by making it easier and less expensive for installers to deploy solar energy systems.

Collecting shading information typically uses equipment set at various positions on the proposed installation site. Typically, only a limited number of positions are used because of time and resource constraints on the installer, resulting in gaps between data points. Often, shading data may be collected for only one or two points. Because of these gaps in the data set, a solar energy system design based on the data collected with current methodology may not actually result in optimal positioning of components such as solar panels. Presently existing ways of system positioning are thus sub-optimal, highly variable, and can lead to a significant reduction in energy output as compared to an optimal system design for the same site.

### SUMMARY OF THE INVENTION

Embodiments of the present invention include methods of performing shading analysis on a given surface. The shading analysis software provides a method for mapping shadows on a surface to determine the efficiency of a planned solar installation.

Additional embodiments may include a method of designing photovoltaic (PV) solar energy collector systems based on mapping shadows on a surface. Further embodiments may include a system for optimal positioning of solar panels to maximize energy production.

Some embodiments may further include shading analysis software for generating time-annotated light intensity maps on a given surface. For example, 3D models of the surface of interest and of its surroundings may be used to determine the path of light from the sun onto the surface utilizing ray tracing. Iterative processing of the light paths from the sun over time provides data regarding light on the surface over specific periods of time. The result may be information regarding intensity of light or, in the absence of light, shading.

### DETAILED DESCRIPTION OF THE INVENTION

In the following description, the term “solar energy system” may be used to refer to a system which converts solar (light) energy into another type of useful energy, such as electricity or heat. Examples of solar energy systems include, but are not limited to, photovoltaics (also referred to in the art as PV) and solar thermal systems. Photovoltaics convert light directly into electricity and are commonly referred to as photovoltaic panels, modules, or cells. Solar shingles may be photovoltaics in a form factor that allows the shingles to be installed with, and perhaps take the appearance of, shingles in a roofing system. Also available are peel-and-stick solar energy collectors that may cover, for example, an individual shingle. Solar thermal systems convert light energy into heat and use the heat for heating, cooling, or generating electricity. These products, and others like them, serve to collect energy from light. The various embodiments of the invention apply equally to any of these implementations of solar energy systems.

Another term used in this description is “power flux.” Power flux is a measure of the light energy received on a given bounded surface (e.g., a roof) in a given time. When the light source is the sun, the power flux may also be referred to as insolation. In either case, the power flux may be expressed in terms of average irradiance, either as power per unit area (e.g., Watts per square meter) or energy per unit area per unit time (e.g., kW·h per square meter per day). For the purpose of this description, insolation and power flux may be used interchangeably.

Throughout this specification, reference is made to light. Light is not meant to imply a particular source or a particular wavelength. This invention may therefore apply to sunlight, artificial light sources, radiation, non-visible light, and refracted light.

Another term used frequently herein is “roof.” While many solar system installations are on roofs, the technology discussed herein can be used with other types of solar energy systems such as ground mount, pole mount, or sea-based floating systems. Use of the term “roof” should therefore not be interpreted to limit the surfaces upon which present embodiments of the invention may be implemented.

### Site Shading and Energy Analysis

Currently available processes for collecting shading information includes collecting shading data from one or two points on a site of interest covering approximately 1 sq. ft. per point. The shading analysis for the point(s) may be averaged over the entire site of interest. A typical site of interest is an approximately 2,000 sq ft rooftop. Thus the data provides optimized relevance for only 1/2000th of such a rooftop. In contrast, embodiments of the current invention use a 3D model to calculate shading information for multiple points. The total number of points may be limited only by the resolution of the model used. For example, the example site of interest with 12-inch×12-inch resolution would be equivalent to 2000 measurements taken using the standard method.

Embodiments of the present invention include a software system that allows users to analyze sites for shading and power flux, design solar energy system layouts, and produce the paperwork necessary for permit applications, all without requiring highly-trained and expensive specialists in solar energy systems. Such features may also reduce the amount of expensive specialty equipment and labor required to collect data and design solar systems.

A user of a system based on the present invention may design solar energy systems without physically visiting the site where the solar energy system is to be installed. The user may also be able to generate system quotes for customers without the costs of conducting site visits. The ability to prepare a solar energy system design and detailed quote without physically visiting the site may significantly lower the cost of deploying solar energy systems.

In addition, a user may design a solar energy system using only data from a 3D model of a locality of interest. The locality may be any site at which to locate a solar energy system. The 3D model may include surrounding terrain, buildings, and vegetation. As such, the 3D model may encompass any structure or terrain feature that may shade the site of interest.

The evaluation of a surface of interest may begin with preparation of a 3D model of the surface of interest and the surrounding topography. The surface of interest may be, for example, a rooftop or a section of rooftop. The 3D model may be a three dimensional map of the rooftop or section of rooftop and the surrounding terrain. The surrounding terrain may further include all shading obstructions, such as buildings, mountains and trees.

A ray trace from the sun to various points on the surface of interest may be performed based on the sun's position for various times of day or days of the year. This ray trace determines if sunlight would hit a particular point on the surface of interest or if the sunlight is blocked. This process may be repeated multiple times and for multiple points on the surface of interest. The sampling may be as frequent as desired and may access as many points as desired by a user. It is envisioned that users may be able to take a ray trace sample at every point in the 3D model and at multiple times per hour for every day of a year. The greater the number of samples, the more accurate the result will be.

The result of the ray trace may be a shadow map for each point at each sample time in the ray trace. The ray trace data may be summed over any or all times to give the total time in sunlight for the chosen points. This data may then be used to generate a shadow map. Statistical analysis may be performed on each spot to determine information regarding when the particular spot receives unobstructed sunlight and when it is shaded. The ray trace data may provide information for annual percentage shading on each spot in the surface of interest. Statistical analysis can be performed over some or all of the surface of interest to provide information for percentage shading. Integration of the ray trace data over the entire time period may further yield the power flux from light striking the rooftop. The power flux may also be calculated from the output of individual ray trace calculations.

The shading information may be used to design a solar energy system. The solar energy system may be designed algorithmically by determining the placement of solar components according to a set of rules and descriptions or models of solar energy system components. The shading information may be provided to a user who may use it, for example, to manually place virtual solar energy system components on a model or image of the site. The calculated power flux may also be used to design the solar energy system. Such power flux information may also be provided to a user as a basis for placement of the virtual solar energy system components on a model or image of the site.

Because users are provided with the ability to analyze sites for shading and power flux, design solar energy system layouts, and produce the paperwork necessary for permit applications without requiring specialists, the amount of expensive specialty equipment and labor required in collecting data and designing solar energy systems may be reduced.

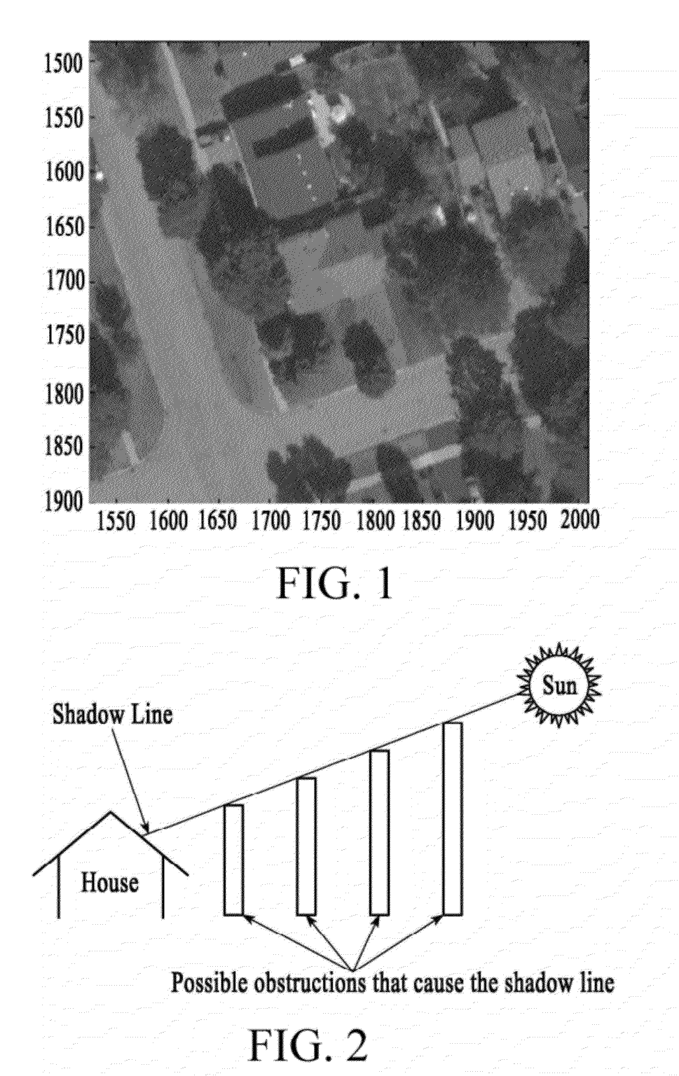

FIG. 1 is a typical overhead picture of a surface of interest, specifically a roof. By using information from one or more such pictures (and from other sources, as described below), a 3D model of the surface of interest may be generated.

FIG. 2 illustrates an exemplary basis for an alternative method of production of a 3D model according to an embodiment of the present invention. Two or more photographs of the same set of surfaces, annotated by time of day and day of year, may be used as input sources. To determine the shadow line on each surface, the location, dimensions, and spectral data may be extracted from each surface within the photo. This process can be performed using machine vision techniques that are well known within the art of image processing.

Given the angle of the sun, which may be known because date, time, latitude and longitude are known, and the position of the shadow line, a family of possible locations for obstructions may be determined for each surface in each photo. Combining the families of possible obstruction locations from multiple photographs creates, for example, a set of algebraic equations with multiple unknowns. Solving these equations simultaneously may create a possibility set of obstructions that is smaller than the possibility set in any one photograph.

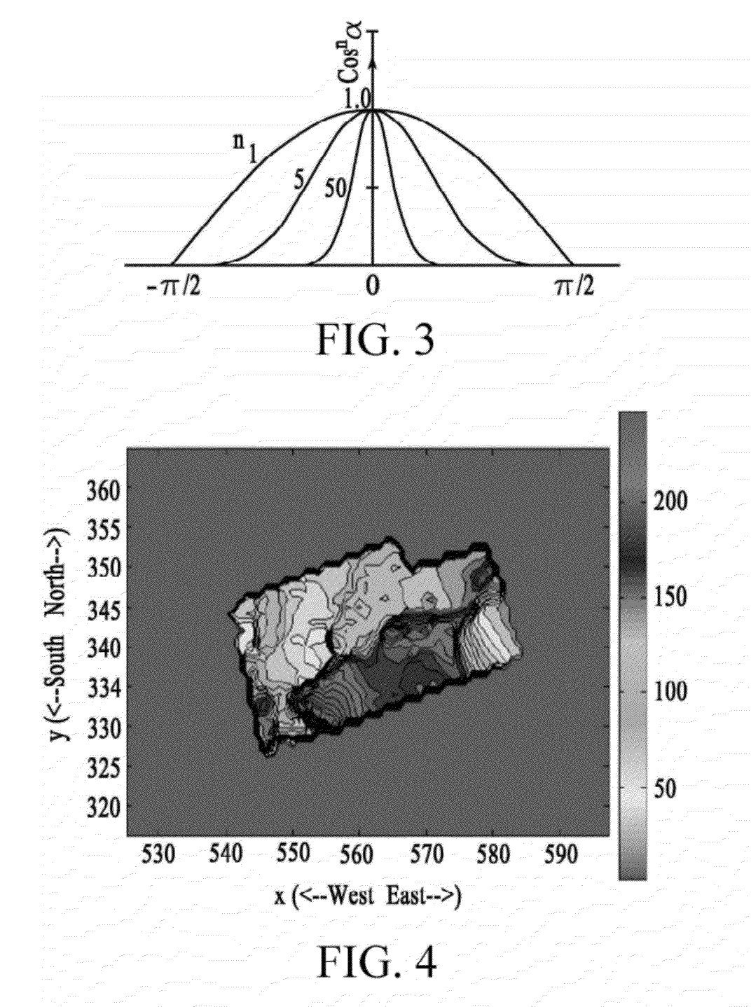

FIG. 3 illustrates a decrease in transmission/absorbance of incident light on a surface as a function of the incident angle for various values of “n” (“n” is a measure of the general reflectivity of the surface—the more reflective the surface, the higher the value of “n”). Specular reflection causes solar system power output to drop as the angle between the line from the sun to the panel and the normal to the surface of the panel increases, even when the power flux may be unchanged. The reduced power output due to the specular reflection effect may be taken into account. Specular reflection is discussed in greater detail below.

FIG. 4 illustrates an exemplary gradient map generated by an embodiment of the present invention. The total amount of light may be summed over a period of time and may be calculated for any of the given point(s) or area(s) on a surface. Following these calculations, a gradient map of light intensity levels, and conversely, shading may be generated.

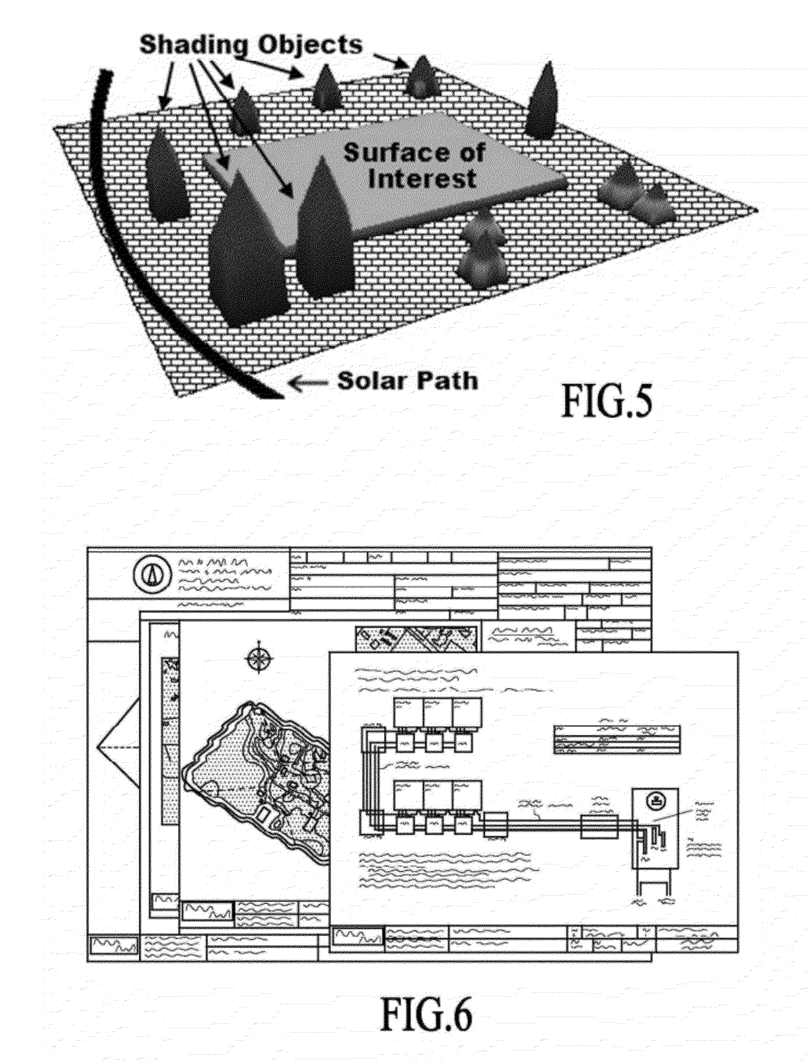

FIG. 5 illustrates an exemplary 3D model that may be generated by an embodiment of the present invention. The model of FIG. 5 shows various shading objects, and the light path that would be taken over the surface of interest.

Some embodiments of the present invention include the ability to automatically produce required paperwork. FIG. 6 is a screen shot of exemplary paperwork that may be generated in accordance with such embodiments of the present invention.

### Enhancing Data about the Surface of Interest

In some embodiments, the surface of interest may be manually outlined by an operator. Regions of a surface of interest (e.g., different areas of a roof that are tilted in different directions) may be identified by the operator, allowing identification of separate geometric areas on the surface of interest. Shading analysis may be performed on a region-by-region basis, providing more accurate processing of discontinuities, such as where two non-co-planar parts of a surface of interest join.

Automatic calculation of the dimensions of the outlined regions may be performed. These dimensions may be used to generate “keep out” regions for placement of solar energy system components. The “keep-out” regions may be defined by structural needs such as separation from obstructions such as vents, or regulatory requirements such as a setback from the edge of a roof.

The “keep-out” area may be added to a model or image of the site. The “keep-out” area may be defined manually by the operator. The “keep-out” area may also be detected by machine vision software or imported from an existing 3D model such as the CAD of the site where the solar energy system is being installed. The “keep-out” area may be an area in which the user does not place components. Solar energy system components may be algorithmically placed according to a set of rules that includes provisions for these “keep-out” areas.

Site drawings may be generated using a database of site drawing templates created for the surface of interest. These templates may be retrieved and merged with the user-generated outlines that form the basis for the site drawings, along with any other data that has been collected or generated about the surface of interest. The site drawings may be automatically generated in a format suitable for construction blueprints or construction permits, and that may include dimensions for some or all lines. The site drawings may be generated or printed on a background template that includes static fields that are the same for every page of the document, such as, for example a title block and an address block.

For reference and/or analytical purposes, he surface of interest may be broken down into sub-regions. Some of the sub-regions may be marked as being permitted for solar energy collections, while other sub-regions may be marked as not permitted.

Parameters for solar energy system layouts may be provided to ensure consideration of physical constraints (e.g., roof support structure), aesthetics, or future obstructions. Permitted versus non-permitted regions may be designated by one or more of the following methods:
(a) Manually by the user.
(b) Through a method that applies a list of legal or zoning setbacks to the region, annotating the region with the markings for permitted versus not permitted.
(c) Through a method that applies a list of technology limitations (e.g., if a mounting system doesn't allow mounting within two feet of a roof edge) to the region, annotating the region with the markings for permitted versus not permitted.
(d) Through a method where an economic payback may be calculated based on a number of factors described later herein. This economic payback may be marked on the map and/or a boundary may be drawn where an economic threshold may be reached, such as sub-regions that have grid-parity electricity generation costs.

Sub-regions may be marked but not determined to be permitted or not permitted. For example, an unknown obstruction may have a keep-out region marked around it. The user may manually determine whether that keep-out region is honored when placing panels. Where an obstruction (e.g., roof vents) can be inexpensively moved, the user may choose not to honor the keep-out region around the easily moved obstruction that would otherwise block optimal positioning of a portion of a solar energy system.

The 3D model data may be used to deduce various angles for a site or outlined surfaces of interest. Preferentially, the angles are between various planes on the region of interest such as multiple facets of a rooftop. The angles may be calculated with respect to a plane of reference (e.g., the horizontal plane), or relative to various other planes in the surface of interest.

Shapes of various elements and angles between such elements may be derived using curve fitting methods. Shapes and angles on the surface of interest may be derived by the method of least-squares, for example, in which the actual data is compared to a parametric model, and the sum of the squares of the differences between the actual data and the parametric model is minimized by modifying the parameters of the model using methods known to those skilled in the art. Such a parametric model may take many forms, including but not limited to the following:
Linear (e.g. y=ax+b, where a and b are the parameters)
Polynomial (e.g. y=aₙ xₙ+aₙ₋₁cₙ₋₁+ . . . +a₂x₂+a₁x+a₀), where aₙ to a₀ are the parameters)
Other forms that those skilled in the art will recognize, such as logarithmic, exponential, etc.

The surface of interest may be compared to members of a database of parametric models. For each model, various parameters may be varied to optimize a figure of merit such as minimizing the sum of squares of the differences between actual data points and the parametric models. The model with the best optimization may be chosen as the true model.

A database of predetermined surface shape models may be used to model the expected shape of the surface of interest. The surface of interest may typically be a roof, and the region of interest being modeled may be a roof face.

The surface shape models in the database may have one or more variable parameters, such as tilt with respect to the horizontal plane. The surface shape models may be fixed with respect to an external reference such as the horizontal plane.

A model surface shape may be selected by finding the model shape in the database that generates the best figure of merit, (e.g. the smallest sum of squared errors) with respect to the 3D model data across the entire surface being modeled. This technique may be iterated over multiple regions of the surface to identify a model that reflects the actual shape of the surface of each individual region. This may be beneficial for surface shapes that are not easily modeled by fixed planes, linear approximations, or other closed form equations. Such surfaces of interest may include, for example, discontinuities, curves, or other shape changes over their surface.

The surface of interest may be split into a series of sections. In the limit, each and every point or combinations of points on the 3D model may be modeled as a separate section. A plane may be fitted to each section using techniques known in the art. The model of the entire surface may be the aggregated model of these planes.

The source 3D model data may be updated after the local curve fitting is completed. Updating the 3D model data provides consistent data for analysis functions such as determining roof pitch.

The 3D model information may be processed to generate cutaway or section views. Generating such views may include mathematically transforming slices of the object of interest normal to one axis into a 3D representation and then re-transforming into slices of the same object normal to a new direction. The slice direction may be taken horizontally through a building, normal to important structural features within the building.

The roof pitch and angle measurements may be presented to a user through a user interface. Automatic generation of some or all internal structure of the building may be provided based on the processed 3D model data and clues either provided by existing information (e.g., by the span length) or by user-provided information (e.g., the user is asked if the trusses are steel or wood).

Manual generation of some or all internal structure of the building may be performed by the user through a user interface which presents the external shape that was determined through the 3D model data. The user may generate internal structure through a drawing function and/or a series of multiple choice questions that allow for creation of the internal structure.

The 3D model may also be used as an input to generate possibilities for internal structure and to create a series of questions that resolves the unknowns needed to accurately model the actual internal structure of a building or other structure.

### Alternative Input Data Sets

Alternative input data sets may also be utilized. The surface of interest and surrounding surfaces may be represented by a 3D model. The model encodes a description of the surfaces in a digital format. The 3D model may be stored in a Geographic Information System (GIS). The data for the 3D model may come from a number of information sources, including one or more of the following:
a. Computer generated models (e.g., extracted from the CAD data for a building)
b. A 3D scanner
c. Manual measurements (e.g., surveying)
d. From analysis of stereoscopic image pairs (e.g., aerial imagery of two or more offset images are analyzed to create a three dimensional digital surface model). Height information is extracted from the stereo image pair for three dimensional data points of objects in the photos.
e. LIDAR, SONAR or other range-finding techniques
f. Existing digital surface models (DSM) datasets
g. Existing digital terrain models (DTM) datasets

Data from multiple sources may be combined into a single dataset (e.g., through a GIS system). Data from one or more data sets representing existing surfaces may be combined with data from other datasets to improve the accuracy and quality of the analysis of the resulting model. For example, a low-resolution digital terrain model generated from satellite imagery may be combined with a high resolution model generated through stereoscopic image pairs of a building site. The low resolution digital terrain model would be adequate to provide shading due to high terrain (e.g., mountains), while the detailed building site model would provide information needed to analyze shadows cast by vegetation and building geometry.

The model described above may be combined with CAD for a proposed structure, which allows analysis of shadows cast by and onto the new structure. Shading information may be extracted directly from images as follows:
a. Two or more photographs of the same set of surfaces, annotated by time of day and day of year, are used as input sources.
b. To determine the shadow line on each surface, the location, dimensions, and spectral data may be extracted from each surface within the photo. This process can be performed by machine vision techniques that are well known within the art of image processing.
c. Given the angle of the sun, which may be extrapolated from the date, time, latitude, longitude, and the position of the shadow line, a family of possible locations for obstructions may be determined for each surface in each photo. FIG. 2 illustrates an exemplary surface and calculation.
d. Combining the families of possible obstruction locations from multiple photographs may create a set of algebraic equations with multiple unknowns. Solving these equations simultaneously may create a possibility set of obstructions that is smaller than the possibility set in any one photograph.
e. Depending on the number of surfaces and number of obstructions, two photographs may sometimes be enough to deterministically find the height and location of obstructions.
f. The calculated obstructions may be placed into a 3D model. The 3D model may be used as input to processes that are described herein.

Data from radiation detectors or light metering systems may be used as an input to the above described technique instead of photographs.

In some instances, it may be desirable to be able to trade off calculation speed against accuracy. The density of the points on the surface of interest for which shading calculations are performed may be settable by the user. A single point in the center of the surface of interest may be used to represent the entire surface. Alternatively, the shading at two or more exemplary points within the region may be calculated, and a function used to determine shading for the entire region. Possible functions that may be used include averaging the exemplary points, choosing the minima or the exemplary points, and/or any other linear or non-linear transform of the set of data.

Images taken from grossly different angles (e.g., 45 degree south and 45 degree north) may also be used for image analysis. Using multiple sets of images may allow a more accurate representation of side views of buildings. Such images may be combined with standard stereo image pairs to provide a more complete digital surface model data set.

### Fusing Data from Multiple Sources with the 3D Model

In this description, reference is made to a Global Positioning System (GPS). Global Positioning System may encompass any form of global navigation system, including current and future global navigation satellite systems. GPS may include, but is not limited to, Galileo, Beidou, Compass, DORIS, IRNSS, QZSS and GLONASS.

The 3D model may be stored in a database. Such a database may include positional data, maps, or images related to the 3D model, including aerial images or satellite images of the area upon which the 3D model is based.

The 3D model may be overlaid or combined with geographic data. Such geographic data may include, for example, spatial coordinate data such as that generated by Global Positioning System, Geographic Information Systems, and/or maps. Other examples of such data include attribute data such as local weather information, utility rates, school districts, and a mixture of spatial and attribute data.

Global Positioning System software and data may be used. Spatial coordinate data from the Global Positioning System (e.g., position of a handheld data collection tool used to mark specific features on a rooftop) may be used as the index for the spatial position of the data that may be inserted into the 3D model.

A Geographic Information System may also be used. Interfacing with a Geographic Information System may facilitate combining 3D model information from large areas to individual buildings. Information regarding individual surfaces may be combined into a larger geographically oriented database. This larger geographically oriented database can increase the accuracy of the ray trace by taking into account surface features that may not be available from a single source, such as large-scale terrain data, local high resolution imagery, and 3D CAD data from present or future buildings. Multiple 3D models of the same area may be combined to provide a 3D model that has a higher resolution than any of the individual input 3D models. The combination of such models may use data processing techniques known to those skilled in the art.

The 3D model may be overlaid on a photographic image of the site of interest and mapped to the image. The 3D model and the photograph may also be scaled and cropped to provide matching spatial positioning even though they may be at differing resolutions.

The 3D model may be matched to a map or image point-for-pixel or pixel-to-pixel such that pixels on the image may be matched to points on the 3D model. Each pixel in the image may correspond to a point in the 3D model to faithfully create a 3-D visual representation of a location with a positional error at any point.

Images of the site of interest may be distorted with respect to the 3D model such that pixel-to-pixel or point-for pixel matching as described above results in systematic positional errors. For example, any or all of the following sources of error might apply: the image and 3D model may have different resolutions; the images may be modified through such processes as orthorectification, stretching, and skewing; physical defects or limitations of the image acquisition source, such as lens defects; and asymmetry of CCD imaging pixels may distort the image in one or more dimensions.

Each pixel in the 3D model and the image of the site of interest may be associated with a terrestrial system coordinate to correct for differences in positioning or resolution between the 3D model and a map image.

### Predicting Energy Production

Embodiments of the present invention include methods of predicting the energy output of a given solar energy system. Because of inefficiencies of solar collection technology, the energy output of a solar energy system will always be lower than the solar power flux on the surface upon which the solar energy system may be mounted. An expected energy output of the solar energy system may be calculated from the solar power flux on the surface of interest.

The predicted energy output of the solar system may be modified by mitigating factors. Modification may be made on either or both of the following levels:
a. The percentage of light energy captured can be calculated as any or all of:
   i. An average of the sum over the entire year
   ii. An average of the sum over some shorter time period
   iii. A discrete value at the time the shading or power flux is calculated.
b. These modifications may be determined for individual components of the solar energy system. The modification for the entire solar energy system can be determined by summing over all the components of the solar energy system. These modifications may be estimated for some collection of components, up to and including the entire solar energy system.

Energy collection is maximized when a solar energy collector is normal to the path of a beam of light. Since the path of the beam of light will vary according to time of day and day of year, the surface of a fixed solar energy collector will often not be normal to the path of the ray of light, and therefore will collect less energy than a similarly-shaded surface of the same area that is placed normal to the sun. Energy collection predictions may account for tilt and inclination by calculating a projected area that is normal to the rays of sunlight for various times of day and days of year, and integrating a group of these calculations into total expected energy production over a time period.

The power flux and expected system power output may be calculated to determine what would be expected under ideal conditions and without shading. This ideal output may be a useful estimation of an expected upper bound on energy production.

In some instances, the actual power flux may be calculated separately from the ideal. In this case, one measure or estimate of the expected energy output of the solar energy system may be the product of the total power flux over the area of the solar energy system and the rated output of the system.

Changes in energy output for solar energy systems may be anticipated based on the properties of the components. Expected energy output for a particular solar energy system, collection of components, and/or individual collectors may be calculated and further modified by some combination of any or all of the following:
a. Modifying the total calculated energy output by a family of conversion factors based on the brand and model number of the solar panel chosen. This family of conversion factors may include parameters that are affected by data that is known for a particular set of inputs. For example, a solar panel's conversion factors might include energy conversion efficiency for direct sunlight, energy conversion efficiency for diffuse sunlight, and a coefficient that represents degradation of efficiency versus temperature.
b. Modifying the calculated energy output by a conversion factor correlated to the efficiency of energy converting devices such as inverters or DC-to-DC converters. These types of devices, which transform the electric out of the solar panel to a different voltage, current and/or frequency, always have less than 100% conversion efficiency. The usable solar energy system output will therefore be lowered by the energy losses.
c. Modifying the calculated energy output by the expected energy losses due to resistance. This will be important as the solar energy system may be placed farther from the connection to the electrical service.
d. Modifying the calculated energy output by a combination of any or all of the above effects and others

The solar panels may be evaluated during their “burn-in” period. For example, amorphous silicon solar panels which are rated for a particular output by the manufacturer may often undergo a “burn-in” period which may last for hours or weeks, during which the performance will decrease.

Averaged historic weather data or weather models may be used as an overall multiplier to increase the accuracy of the energy output model. Predicted weather conditions (based on historic data and/or weather models) for a particular time and day of year may be used to calculate temperature, cloud cover data, soiling estimate, snow cover estimate, etc. This data may be combined with mathematical models of the solar collector (e.g., energy output derating versus temperature and/or energy output derating versus diffused light) to generate a weather-corrected expected energy output for the time of day and day of year, which may be summed to determine total energy collection far more accurately than current models.

The energy output of a solar energy system can also be affected by a variety of local geographic and atmospheric properties such as latitude, local altitude, atmospheric conditions and weather, including clouds, haze, dust, storms, microclimate, or unusual degrees of atmospheric clarity. The output may also be affected by ambient temperature and wind speed, to the extent that changes in system temperature affect performance. The predicted solar energy system output may be modified by anticipating the effects of the aforementioned factors. For example, the predicted output of the solar system may be modified for any combination of latitude, longitude, and local altitude.

Embodiments of the present invention may further include commercially available predictive tools for weather conditions. These models may be used to modify the expected performance of the solar energy system. Predictive models and tools for weather prediction and for approximating atmospheric conditions, ambient temperatures, and wind speeds are known to those skilled in the art. Such a model or tool might include data from a number of sources, including but not limited to the National Aeronautics and Space Administration (NASA) and the National Oceanic and Atmospheric Administration (NOAA), among many others. A predictive model may or may not provide useful predictive data in either or both of small periods of time or small units of geographic area.

Communication with such a model or tool may occur through an application programming interface or a database of weather and atmospheric condition predictions based on location criteria such as, but not limited to, zip code, county, or city. The prediction/approximation model may be pre-computed and stored in a GIS database.

There are large numbers of solar energy system components on the market. For example, it has been estimated that there are currently more than 400 companies manufacturing PV panels as of 2009. Reporting on the performance and limitations of these components varies in quality and utility. Often, the data may be reported in different formats that make gathering and analyzing all useful data difficult.

A database of objects representing models, classes, etc., of various solar system components and their attributes may be created or an existing database may be utilized. Information regarding performance attributes of the real-world solar energy system components may be stored as properties of the objects. The objects and their properties may be standardized to allow for rapid data retrieval and efficient comparison between and among different brand, types, or classes of solar energy system components.

Embodiments of the present invention may further include database objects representing a solar energy system component and may also include statistical attributes and/or predictive models, as well as specific attributes that may be quantifiable on the level of a single component of the solar energy system.

Database objects may further include models of groups of components, up to and including complete solar energy systems. The database objects may be modified individually or in sets. It will often be necessary to create a database object that represents a solar panel or solar component before having all useful data about an object. In some cases, it may be possible that new regulations, measurement techniques, or other factors will require that all objects be updated with new information or new attributes. In such cases, attribute values or even new types of attributes may be added to the database objects according to processes known to those skilled in the art.

Information regarding an actual solar energy system and solar energy system component performance data, along with weather and atmospheric condition data that is collected in the field, may be used. Attributes may be added to the database object representations of the solar components or solar panels. Such database objects may represent the performance, including structural performance, statistical data on failure modes, failure times, the energy conversion efficiency, and the actual energy output of solar panels and components under real-world conditions.

Data from one manufacturer or type of solar system component may also be used to infer the unknown values for another. For example, the known temperature coefficient data averaged from panels with a particular voltage, current, and area may be used as the value for an unknown panel. Such an inference is likely to be highly accurate, as solar panels with similar voltage, current, and area are likely to be made using the same technology which has similar characteristics across manufacturers.

The combination of solar energy system components may create a solar energy system. In some cases, the properties of the solar energy system (e.g., efficiency) may be an additive property of the attributes of the solar energy system components. Where such complex effects are known, nonlinear functions may be incorporated into database objects representing collections of solar energy system components and individual solar energy system components.

Energy production calculations may also be modified based on the actual attributes of specific combinations of solar energy system components, including the nonlinear functions, as opposed to the simple addition of solar energy system component attributes. Nonlinear empirical data from a particular group of components and conditions (e.g., solar panel A with inverter B under radiation conditions C and temperature D) may be combined with nonlinear empirical data from other groups of components (e.g., solar panel A with inverter A and solar panel B with inverter B under similar radiation and temperature conditions) to model the nonlinear characteristics of each individual component. This may be determined by setting up and solving multiple simultaneous equations.

Real-time solar energy system and solar energy system component data may be collected utilizing monitoring tools. Solar energy system monitoring tools, such as the Enphase EMU, are commercially available and known to those skilled in the art. In these embodiments, the predicted energy output of the solar energy system at any point in time or over a period of time can be compared with the actual solar energy system output. The predictive models for solar energy system output may be dynamically changed in response to some level of statistically significant deviation of actual performance from predicted performance. These changes can be made on any level from the local level (e.g., for all systems within a specific zip code) to the national or even global level. For example, the changes may include modification of parameters of a model or a weight within a neural network.

In some cases, a solar energy system may be installed utilizing solar energy system components that have been previously used or that have undergone aging. These solar energy system components may have, for example, been reclaimed from previous service in the field, or stored in a place or for a period of time that may affect their performance. Modeling may reflect the changes that prior use or aging may have on the performance of the components. An exemplary model may be based on accumulated knowledge of the solar system component performance. The energy output calculations may be modified by the expected effect of the solar energy system component history on performance.

Data from testing of the solar panel or solar component may also be utilized. The energy output calculations may be modified by the expected effect of the solar panel or solar component history on performance. A model may also be based on accumulated knowledge of the solar panel or solar component performance in the future and data from tests of the solar panel or solar component performance. The energy output calculations may be modified by the expected effect of the solar panel or solar component history on performance.

Environmental factors may affect energy output, and therefore the economics of the solar energy system. These factors may be taken into account to modify the energy output calculation. Environmental factors may include pollution, as both atmospheric and sediment may obstruct or amplify sunlight or otherwise affect local temperatures or weather. Obstructions not currently in existence or not currently meaningful may still have a likelihood of affecting the energy output of the solar energy system in the future. These include, but are not limited to, new construction, growth of vegetation, and additions to existing construction.

In some cases, there may be reflective surfaces that may potentially reflect sunlight onto the solar panels that will in turn be converted to electricity by the solar panel. In such a case, the energy output calculations will be modified upward during the period that the surface is reflecting light onto the panel.

Some weather and environmental conditions may result in the scattering of sunlight, resulting in a mixture of diffuse light and direct light. For example, cloud cover may cause such an effect. The solar panel efficiency may be affected either to the positive or the negative by such affects. For example, mono-crystalline silicon may not generate as much energy from diffuse light as a CdTe or amorphous silicon panel would. In such cases, the available light of both types, diffuse and direct, will be calculated, and the attributes of the solar panel used to calculate efficiency may be different for either diffuse or direct light.

Accurate and optimized design of solar energy systems involves shading tools that accurately report energy production for a variety of different types of solar collectors. Current methods of shading analysis for solar energy systems (e.g., Solar Pathfinder, Wiley Electronics ASSET, Solmetric SunEye, etc.) do not incorporate any mechanism for predicting energy production by type of solar collectors.

Every solar collector exhibits a property known in the art as specular reflection, wherein some light striking a surface is reflected rather than absorbed or transmitted. Specular reflection is directly related to the sine of the angle an impinging light ray makes with the surface normal—thus a ray of light that is parallel or nearly parallel with the normal to the surface will be largely absorbed or transmitted, and one which is very nearly parallel to the surface will be largely reflected. Specular reflection may be calculated according to any process known to those skilled in the art.

Specular reflection causes solar energy system power output to drop as the angle between the line from the sun to the panel and the normal to the surface of the panel increases, even when the power flux is unchanged. This angle is referred to in the art as the incidence angle. As the incidence angle increases, direct sunlight impinging on the solar panel tends to be reflected and not absorbed or transmitted through the material. The reflected light fails to initiate the generation of electricity (for PV) or heat (for solar thermal). At incident angles approaching 90 degrees or π/2 radians, essentially no light will be absorbed by the collector, a condition which occurs early and late in the day. The level of specular reflection may change with wavelength, frequency or energy of the impinging light, the polarization vector of a particular photon, the refractive index of the surface material, the refractive index of the transmitting material, and/or the surface conditions of the material.

FIG. 3 shows a decrease in transmission/absorbance of incident light on a surface as a function of the incident angle for various values of “n” (“n” is a measure of the general reflectivity of the surface—the more reflective the surface, the higher the value of “n”).

Because light reflected off the surface of the collector cannot be used by the collector to create useful energy, reflection directly affects the power output of the solar energy system, and can dramatically change the economics of ownership of a solar energy system. Different types of solar collectors may have different specular reflections for a number of reasons. For example, the individual solar cells may be made of different materials with different reflection curves, such as monocrystalline Silicon or CdTe. The solar collectors may also have different protective coverings such as polycarbonate plastic or soda lime glass, which also have specular reflection curves. Embodiments of the current invention use specular reflection data for the particular materials used in the solar collector to derate predicted power output.

The specular reflection curves may be calculated for common classes of solar collector materials. In this method, energy output predictions may be modified by the anticipated degree of reflection for different times of day and positions of the sun in the sky. For collectors with multiple surfaces having specular reflection (such as PV cells encapsulated in glass), the level of reflection may be determined from any such surface. Typically, the surface with the fastest increase in reflection with incident angle will be used.

Solar collectors commonly have multiple layers of materials with differing refractive and reflective properties. For example, crystalline silicon PV cells may be often encapsulated between glass sheets. The overall output may be modified by the anticipated reflections from multiple surfaces internal and external to the solar collector.

Solar collectors may have anti-reflective coatings applied by the manufacturer. These coatings generally greatly reduce the specular reflection from the surface to which they are applied. Specular reflection curves may be determined for various anti-reflecting coatings. This knowledge may be used to modify energy output for solar collectors with anti-reflective coatings.

Some solar panel and solar cell technologies will harvest only a portion of the visible light spectrum. For example, certain heterojunction types of solar cells may be optimized to absorb and utilize only red or green light or light in the wavelength range 650 nm to 700 nm. The energy output of the solar energy system may be modified formulaically according to the availability of light in certain portions of the visible, UV, and infrared spectra.

Objects that would be viewed as creating shading on a wide spectrum basis may be viewed as not shading with respect to the spectral range that the solar energy system absorbs and generates electricity in response. For example, a heterojunction solar system as described above may be partially shaded by a large pane of glass designed to reflect all light with a wavelength below 650 nm and above 800 nm. For the purpose of calculation with respect to this solar energy system, the pane of glass would be considered to not be a shading object, while for other types of solar energy systems, the pane of glass could be considered a shading object. Such spectral information about shading objects may be determined according to processes known to those skilled in the art.

In some instances, insolation may be calculated at multiple spectral ranges or for multiple exemplary wavelengths, frequencies, or energies of light. In some instances, atmospheric conditions that change the spectral content of sunlight (e.g., sunlight may be redder near sunrise and sunset) may be modeled and taken into account when calculating energy output for a given time and date.

In some cases, a formulaic derivation of the degree of specular reflection may not be available, and the specular reflection for a solar collector or solar energy system of interest may need to be determined empirically at discrete steps. Discrete methods may be used for determining predicted solar energy system energy output and economics as modified by specular reflection. A database of absorption/reflection ratios may be maintained at various predetermined incident angles. For a particular solar energy system design, at some step in the calculation of power flux and energy output, the actual incident angle will be nearest to one of the incident angles in the database, and in this event the power flux may be modified by the absorption/reflection ratio in the database. The absorption/reflection ratio for a solar energy system with an incident angle between two entries in the database may be imputed formulaically from the absorption/reflection ratios for the incident angles included in the database. Specular reflection data may be used from any or all of the following: General classes of solar collectors that may be based on collector type, the collector materials, and collector form factor. Data derived through correlation with other solar collectors produced by the same company or manufacturer

All light that is at or above the critical angle may be excluded. Critical angle describes a boundary condition in optical phenomena. When a ray of light strikes a medium boundary at an angle larger than a particular critical angle with respect to the normal to the surface, light is reflected.

The power output of the solar panel may be calculated without analyzing the angle of the incoming light with respect to the normal of the solar panel or the critical angle. In this application, the percentage of time the sun spends in each portion of an arc relative to the normal to some reference (e.g., the ground, a flat plane at sea level, or a pre-determined series of south-facing planes canted with respect to the normal to the Earth's surface at a specific latitude or latitudes) will be pre-computed. This calculation includes generating a surface (preferably the surface is a portion of a sphere, but it can describe any shape) that covers the portion of the sky that the sun's path traces over the entire year and either weight sections of the surface according to the amount of time the sun is in each section over the year or integrate the areas outside the critical angle in the next step. The normal to the solar panel may be determined. Further, portions of surface may be determined where a straight line drawn from the surface to the solar panel makes an angle with the normal of the solar panel that is equal to or greater than the critical angle. Inputs may be limited to include only input from times/portions of the sky where the incident angle of the sunlight is less than the critical angle.

The critical angle of a solar panel being analyzed may be calculated as known to those skilled in the art. The ray trace may be used to determine if the angle of the sun to the normal of the solar panel is at or above the critical angle at every calculation step. The power output predicted for the solar panel may be attenuated during those calculation steps when this is true.

The critical angle of panels may be considered. Within the ray tracing, the angle of the light paths relative to the roof surface may be calculated, summed into the energy total when within the critical angle, and excluded from the energy total when outside the critical angle. Energy production may be calculated simultaneously for n different possibilities of angle of setting of the solar panels. The energy and critical angle calculations may be performed for each of these angle settings. The ultimate angle for the solar panels may be chosen as the angle that resulted in the maximum energy over the year, or as the maximum annual earning for selling wholesale power, after applying factors that correct for energy value according to time of day and day of year.

The expected solar energy system output may be determined based on the expected output for individual solar collectors, or groups of solar collectors. Where individual solar collectors in the system are not all aligned parallel to the same plane, the above modifications can be separately determined for each solar collector. Determinations may be made for every moment and pixel at which the ray trace is calculated. The above energy output determination may be made for groups of panels in the same plane.

Models for sun tracking may also be included in which the tilt and inclination of the solar collectors change over some time according to either a predetermined algorithm or through metrics that are collected at the site. For each time, the tilt and inclination of the solar collector may be determined (either algorithmically from the time, date and location, or modeled according to conditions at that time applied to the tracking control algorithm), and the ray trace may be performed based on this tilt and inclination.

In some instances, the brightness of the modeled light may be multiplied by the energy conversion response of the solar panel according to brightness to determine energy output at that time. Average temperature for time of day and day of year may be used to calculate temperature derating, which may be used as a factor to determine energy output for that time and day.

### Display of Information/User Interface

An example of the display capability is shown in the generation of a gradient map. The total amount of light may be summed over a period of time and may be calculated for any of the given point(s) or area(s) on a surface. Following these calculations, a gradient map of light intensity levels, and conversely shading, may be generated. An example of a gradient map is illustrated in FIG. 4.

An operator may select a specific solar collector from a list of vendors and/or specs (e.g., a specific PV panel). The correspondent dimensions and performance specs of the selected solar collector module may be displayed and used for calculations in the system design. The operator also has the option to add custom specs to the list or create a new spec based on an existing item in the list.

In the user interface, an operator may place selected solar collector modules on a surface in an aerial image or energy map. The operator may be able to move the solar collectors around, change orientations, align multiple solar collectors, or change the specifications of the selected solar collectors.

The system provides detailed information for the output of individual components of the solar collector systems after placement on a surface (e.g., for a rooftop PV system), the output of each PV panel on the surface will be shown.

An operator may define areas to be analyzed. This may be accomplished by either manually drawing lines on the image through a user interface or simply choosing a desired surface which will be automatically bounded through, for example, machine-vision algorithms. Dimensions (e.g., length, pitch, orientation, etc.) of the selected lines and areas may be automatically calculated and displayed (e.g., the operator may click on a roof in the image and the roof edges will be automatically identified, selected and the lengths of the roof edges displayed).

3D model or aerial imagery may be used to automatically identify obstructions in the surface of interest (e.g., vents or sky light on a rooftop). Obstruction identification may be provided for objects on a surface that would limit solar panel placement. Manual and/or automatic call out of obstructions such as skylights, satellite dishes, and vents, etc. may also be provided.

Vents and other easily movable roof obstructions may be treated as movable objects within the user interface, optionally including an economic analysis as to whether it may be less expensive to move the obstruction or have a less efficient solar energy system due to sub-optimal solar panel placement.

Information may be updated across the data types, inputs, and outputs. When changes are made to any data type, resulting updates may be made to linked data types. In one example, an update in the stereo image pair would result in generation of a new 3D model, new ray tracing and shading analysis based on the updated 3D model, and updated solar energy system layout. In a similar example, revisions to the 3D model would result in notation of differences between the stereo image pairs and 3D model, new shading analysis, and updated solar energy system layout.

### Automatic Design

Placement of elements in a solar energy collector system may be automatic. A set of rules may be generated, based on building requirements and other criteria. For example, some jurisdictions require a walkway of a certain width around the edges of a roof. If the jurisdiction of the surface of interest had this particular requirement, this requirement would be added to the set of rules. Generally, the rules will consist of a union of universal rules, geographically specific rules (e.g., those in a legal jurisdiction), equipment-specific rules (e.g., a particular brand of solar panel and/or mounting system), and user-generated rules (e.g., where a particular surface cannot receive solar panels because of aesthetic considerations).

An equation for payback may be calculated that includes consideration of several factors. The factors may include, but are not limited to, cost of solar equipment, added cost associated with how elements are mounted on the roof (e.g., mounting in landscape versus portrait mode, likewise mounting panels with or without a gap, may have different costs), energy production for that particular area on the surface of interest, and comparative costs of energy from alternate sources such as electricity from the grid.

Solar energy system components may be selected from a database and positioned as necessary to meet all rules and to maximize payback. Many known algorithms may be used to meet the established criteria.

Mounting options of solar collectors in portrait and landscape orientations may be provided. Also, the solar collectors may be placed at non-parallel angles to maximum solar energy collection. Collectors may also be tilted.

### Relative Economic Value

Analysis may be provided in terms of economic value for solar energy system installation with automatic placement compared to a user selected layout. Aesthetic appeal of solar energy system layouts, for example, may be important to some consumers.

Comparisons may be made between economic values of solar energy systems based on different solar collector models/specs. The economic comparison may include values such as solar collector cost, installation cost, inverter cost, wiring cost, mounting system cost, electricity generated per time period, maintenance cost, warranty cost, monitoring cost, etc. Additional values, such as value of specific brand or aesthetics, can be added or adjusted by user.

The time value of solar energy system installation may also be considered based on the underlying surface structure condition. Factors considered may include, but are not limited to, solar energy system re-installation cost, savings from electricity payments, pricing trends of solar energy systems, replacement cost of the underlying surface, etc. For example, replacement cost may be a factor if a roof has five years of useful life left. An exemplary consideration may concern whether it may be more economical to install the solar energy system now but change the roof and re-install the solar energy system five years later or to wait five years to replace the roof and install a new solar energy system at that time.

Relative economic values of various solar energy system mounting techniques may be calculated. Comparisons of the difference in electrical output versus the cost differences for stationary and different types of sun-tracking mounting may also be calculated.

Different methods of solar energy collection may be modeled and compared. System output and cost may be calculated for two or more solar collector systems (e.g., a system consisting of a collection of photovoltaic panels, concentrated solar thermal (CST), and concentrated solar photovoltaic (CSP)).

### Automatic Form Generation

Automatic submission of forms may also be provided. Forms may be submitted using electronic transmission (e.g., facsimile, email, send to printer, or send to FedEx/Kinko's).

A database of construction permit form templates may be created. For each solar site, the templates may be merged with the local site data, such as address, shading information, etc.

Whenever a solar energy system is to be installed, forms may be required by the local building department. These forms can be quite complex (e.g., wiring diagrams, structural diagrams, load calculations, etc.) and may require great expertise to fill properly.

Site specific data may be collected in a step-by-step interview similar to that used by consumer tax preparation software. This process allows a non-expert to do the expert work of completing the often complex paperwork associated with solar energy system installation. This process also reduces errors and substantially eliminates the cost of visiting the site. Users may also be provided with details regarding all needed paperwork for permit applications and construction.

The operator may be prevented from continuing with the process until necessary paperwork is completed. Prevention may occur in different formats including requiring the necessary information before allowing operators to continue with information input while preventing generation of the final paperwork.

Forms and documents may be created from the 3D model data, shading data, automated system design, and the answers provided to the questions described above. Each form or document may be created by retrieving a template from a database that indicates boilerplate text and areas where data is to be provided, as per a particular form for a particular community. The template may contain instructions as to how to create the information to fill in the places where data must be provided (e.g., how to calculate a value from the known information) or which text item to retrieve for the particular blank.

Drawings for the building permit may be created from the 3D model data, shading data, automatic system design, and the answers provided to the questions described above. These drawings may be pre-defined with parametric modifiers. For example, an electrical diagram may contain an AC disconnect and wiring from the panels to the AC disconnect, while the number of solar panels and inverters may be generated parametrically, pre-wired together in a predefined way. The data for the parameters may be retrieved from the data set that was created and entered for the particular solar energy system for which building permits are being submitted. The master parametric drawing may be retrieved from a database, which stores different parametric master drawings as needed for the building permit of different communities. In some embodiments of the invention, an additional layer of indirection may be included (e.g., the database for Palo Alto, Calif. may indicate that a three-line electrical drawing must be included). Therefore, a three-line parametric master drawing of the electrical system may be retrieved and may be parametrically customized with data for this particular system.

Data may be entered through either a form or through interview interchangeably. In this mode, forms may be displayed during the interview in response to operator input.

An application that runs on a device located at the site may also be used for collecting site data (e.g., iPhone, laptop, netbook, personal digital assistant (PDA), or iPod Touch). This application would facilitate collection of various types of data, including structural information about the site, photographs for documentation, and information on roof vents and obstructions that might hinder solar energy system placement. The 3D model may be updated with this information.

A connection to external information (e.g., a business server) or an interface to other shading software or databases may be provided. Such connection or interface may allow for receipt of solar energy system layout and costs for reroofing and solar energy systems from previous installations.

Data from mobile applications and shading analysis may be integrated. Information gathered from multiple inputs linked together may be automatically transferred to the forms and updated.

System information and data sheets, such as bills of materials (BOM), may be automatically created.

### Cost Estimation

Cost estimation and creation of sales quotes for solar energy systems may be time consuming and requires specialized expertise with continuous re-education required as regulations, technology, etc. may change rapidly. Typically, solar installers generate cost estimates and sales quotes by hand and employ solar experts specifically for this task. Automation of the process may be limited. Some software, such as a web-based form, may be used to collect information from users, but the system design, calculation of roof angles and the like require a human expert user. This can add a considerable amount of time and effort to the process, thus automating cost generation, sales quotes and similar documents would provide great value.

Some embodiments of present invention include the ability to create a solar energy system design for a roof or roofs from a 3D model. Other data may be used that may be derived from the 3D model, such as a shadow map or power flux map of the rooftop. The design process may begin by creating a 3-D model of a rooftop or rooftops. Any rules may be applied to limit placement of solar elements, such as regulatory “keep-out zones” where zoning or other legal restriction prevents the installation of solar panels. Similarly, the maximum desired system size may be limited by statute. Any other rules may also be applied relating to component selection or placement of solar panels. In the user interface, an insolation map of the roof may be overlaid on the 3-D model, and position models of the solar panels may also be overlaid on the 3D model.

Following installation of the solar energy system components, the predicted energy output of the resulting solar energy system may be calculated. The models of the solar panels may be moved until a maximum efficiency outcome is achieved. Any or all of the system design(s), cost estimation, 3D model, power flux map, and any other material of interest may be returned.

A set of rules may be used, including any combination of the following: desired limits on system size; desired limits on energy cost per unit time, such as price per kilowatt-hour; attributes, including but not limited to size, weight, area, and efficiency; site specific knowledge such as the location of the electric service; and local regulations and restrictions.

Genetic algorithms may be incorporated for optimization of system design. In some instances, these optimizations may be applied globally. In some instances, the optimizations may be performed on a site-by-site basis. Genetic software algorithms and methods for applying them to design tools include those known to those skilled in the art.

An important part of solar energy system design includes calculation of the wind load—the force on a section of a solar energy system or solar energy system component caused by movement of air. The wind load may be upward or downward depending on wind speed and direction, and on details of solar energy system design, location, etc.

The solar energy system area and shape may be automatically determined. The slope of a solar energy system (e.g., on a roof) may be determined either from the roof slope, or from the combination of roof slope and slope provided by mounting systems that do not lay the collectors flush with the roof. From this information, the wind load of the solar energy system may be calculated. In some embodiments of the invention, needed modifications to the building structure and/or solar energy system design may be determined through an expert system.

Total solar energy system weight may be determined. With information on system components, total system weight may be calculated. Load capacity may be determined based on a building's structure and the system design. Needed modifications to the building structure and/or solar energy system design may be determined through an expert system.

Live and dead loads may be calculated on a structure from the solar energy system weight, area shape, and slope. Other information may also be utilized such as local weather patterns and wind speed data. In some instances, the wind speed data may be taken from geographic averages provided in the International Building Code (IBC). Wind speed data may also be taken from historic local records of wind speeds and weather. Conformity to building codes may be calculated and either displayed for an operator, or used as a parameter in the system design rules.

Automated top view drawings of the area of interest and solar energy system layout may be provided. The automated top view may provide the drawings necessary for building permit applications and plans.

Input of various other options such as roof repair, addition of skylights, and bird abatement may be allowed. With information on the cost of these options, the total price of the installation of the solar energy system installation and the options can be calculated.

A price quote may be provided for the solar energy system installation, roof repair, and installation of options.

Embodiments of the present invention further include calculation of cost savings for the solar energy system user. The cost savings may be the difference between the price of electricity the user can obtain from alternate sources (e.g., the grid) and the price of the electricity generated by the solar energy system. Because the solar energy system takes sunlight (which is free) as fuel and may generally be purchased outright by the user, the price of solar energy system generated electricity may be defined as a price per unit power (e.g., dollars per Watt), while electricity from other sources may be calculated as price per unit (e.g., dollars per kilowatt-hour). Some methods of calculating price comparison between gird electricity and solar energy system electricity, such as discounted cash flow analysis, are known to those skilled in the art.

A choice or choices of financing methods may also be considered. Different financing mechanisms may generate different apparent prices per unit electricity. The price comparison may be made between the savings from electricity purchases offset by the solar energy system and the cost of financing the system. In preferred embodiments, the price comparison may be made between a payment or payments on the financing and the cost of retail electricity purchases foregone over the same period.

Calculating price comparisons requires some knowledge of the electricity usage and price paid by the user for electricity from alternate source(s), e.g. the electricity grid. The electricity usage and price paid for electricity from alternate sources by the ultimate user of the solar energy system may be determined. In some embodiments, future usage and rate data may be extrapolated.

The electricity usage and price paid for electricity from alternate sources by the ultimate user of the solar energy system may be determined from historic usage and rate data. Historic usage and rate data may be provided by a utility. The usage and rate data may also be extrapolated from usage and rate information provided by the user.

In many cases, actual historic usage data may not be available. Instead, estimates of electricity usage may be provided. In areas such as those served by PG&E, for example, where a user's electricity rates may change with usage, these methods may also provide estimates of electricity rates. Electricity usage and rates may be estimated by asking users questions about their major appliances. Estimating the electricity usage of individual appliances based on attributes such as type of appliance, age, etc. may be performed by methods known to those skilled in the art. Overall usage due to the major appliances may be calculated. Total usage may also be extrapolated from the appliance information. Other considerations include living area of the building, energy efficiency upgrades, local climate and weather data, statistical data on usage, the presence of air conditioning units and the rate of usage of air conditioning, and the heating system type (e.g., gas, electric resistance or heat pump).

Average or global usage data concerning a particular geographic area may be available. Data on home sizes, including square footage and number of rooms, may be available from sources known to those skilled in the art. Statistical usage may be extrapolated based on home size and usage data over the geographic area of interest.

Average or global usage data concerning a particular demographic or psychographic group may be available. Usage may be inferred based on demographic and/or psychographic data. In some instances, a psychographic or demographic grouping for the user may be determined. This data may be determined in a variety of ways. For example, the user may self-select by providing answers to questions about their habits and/or demographic grouping. In some areas, homeowners cluster by demographic or psychographic grouping. In these areas, the data may be inferred from zip code or neighborhood. In other areas, demographic or psychographic clusters may be inferred from information gleaned from aerial or satellite data (e.g., roofing material or lot size).

The ability to calculate reroof cost estimations for roofers may also be provided. Formulas necessary for the reroof cost estimation may be collected into a database. These formulas may also be combined with other available information to generate a reroof quote.

Cost quotes may be provided on installation of solar energy systems along with the cost of reroofing. The reroof information may be combined with the solar energy system information, generating a reroofing estimation coupled with an estimation of the cost of installation of a solar energy system. The database may further include formulas for cost saving due to the combination of both jobs.

Cost estimates may be automatically generated for a list of potential customers retrieved from a database (e.g., a roofer's previous five year customer list or a database of potentially interested consumers purchased from a lead generator). Using customer site address information from this database, solar energy system layouts and cost estimations may be automatically designed. The completed quote may be used for marketing and sales purposes such as mailing a postcard to each lead describing the economic benefits of the solar energy system that the system designed. A computer generated drawing or picture of the solar energy system may also be provided.

Documents related to each individual installation site or project may be automatically filed. With automated documentation and filing across several projects, back room processes may be simplified for users.

### Inventory/Supply Chain

All necessary components required for the solar energy system installation may be identified by the software system. Additionally, a list for the operator to review may be generated and orders placed automatically through a link to the central supply chain management system. Inventory levels may be checked and suppliers informed in order to prepare necessary components for the site. When inventory approaches an insufficient level, automatic orders may be placed from the central distributor and information provided on the time needed for deliver. Consumers may be alerted with instant feedback as to the time needed for completion of the project.

### Community Planning

A simulation of solar potential for a building or an entire community may be provided. Utilizing the automatic design techniques described herein, each surface of the building or community may be analyzed for its best payback solar energy system. A group of solar energy systems that meet particular criteria (such as financial payback period or total energy production) may be output for consideration of implementation.

Shading and energy analysis of one or more surfaces of interest may be generated. This allows for community level analysis of solar energy system installations. Depending on community energy requirements, solar energy systems can be installed on a limited number of surfaces while meeting demand. Within the community, solar energy system placement can be optimized by sequencing potential solar sites according to suitability for solar installation as per economic payback or other metric(s). Optimized layout options across many surfaces of interest to achieve target system output may be provided.

Objects may be inserted from an independent database into the 3D model. These objects can include planned or expected construction or vegetation growth. This insertion of objects may provide the ability to predict the effects of future neighboring developments on the power flux at the site.

### Smart Grid

Changes in the electrical grid output may be predicted based on external inputs that predict shading changes on one or more solar collectors, which may be PV panels.

Potential system output may be used to determine energy contributed to a connected grid. Applications may include planning electrical grid input with smart grid technology by utilities to ensure grid demands are met.

Electrical grid output may be predicted based on weather forecasts. Weather information may be used to anticipate grid electrical output fluctuations due to changing conditions. This information can be utilized by utilities to manage and optimize their electricity generation controls (e.g., to minimize the amount of spinning reserve that is online).

Radar data (e.g., Doppler) may be used to determine cloud cover and resulting light on a roof. This allows for real-time prediction of solar energy system output in an electrical grid.

Real time shading analysis from images or video may be used to determine system performance based on weather. Embodiments of the real time update provide monitoring of system output. The monitoring provides immediate updates of current system output.

Information from weather modeling systems may also be used. Modeling systems may provide large scale weather predictions with cloud coverage. In doing so, power output from electricity generating solar energy systems, such as PV systems, across large electrical grids can be predicted. Information such as this may be useful for utilities to predict when grids will be saturated or underpowered by solar energy systems. In doing so, utilities can adjust output from other sources to accommodate changes in solar energy systems output.

### Other Uses for Shading Information

Sunlight analysis may be used to determine relative UV degradation of areas of a surface (e.g., a roof). In one embodiment, this information may be used to determine maintenance intervals, to choose between different materials, and/or to use to direct inspections.

Additional features may allow for planning of light dependent features on a roof. Applications, for example, may include layout for skylights and vents. Skylight position may be determined and the ability to select the average amount of light allowable may be provided, as well as the amount of time per year that the skylight is exposed.

An audit of the solar energy system output may also be provided. The modeled output of the solar energy system may be compared to its actual output. The comparison may show where collectors have malfunctioned and may provide warning to users to perform maintenance.

A shading map of the site or surface of interest (e.g., a roof) may be used to determine temperature gradients at various regions during a time period.

### Mobile App

Embodiments of the present invention may further allow for collection of data necessary to the installation of rooftop solar energy systems. Installation of a solar energy system may require the generation and submission of building permit documents, completion and submission of utility interconnection agreements, completion and submission of equipment and materials purchases, and scheduling the job.

Data useful to making and closing sales of solar energy systems may be collected. In addition to much of the data necessary for the installation of solar energy systems, making and closing sales of solar energy systems may involve the collection of customer financial and credit information, and electricity usage. Also involved is the completion and submission of incentive documents and financing applications, and the generation of informative sales collateral.

Operator-entered-data may be collected that is related to the sale, construction and planning of roof-related components, energy efficiency upgrades or other exterior components. Data that previously required an expert may also be collected. A non-expert may be told what data to collect. The necessary forms may be generated automatically. The operator may be interfaced with using a device or with written questions. Interface with an operator may also occur conversationally—such as through a call center or through a voice recognition program.

The sale, construction and planning of components such as solar energy system installation and/or maintenance, roof replacement or repair, and the replacement and installation of related items such as skylights, windows, insulation, bird abatement systems/components, gutters, etc. may involve the creation and submission of permit documentation and completion and submission of equipment and materials purchases. Mechanisms may be provided to collect the data needed for these actions.

Anyone may be allowed to participate in the data entry by providing a mechanism for simplified data collection. Entry of a narrow range of information may be forced. A linear walkthrough of data entry may be provided, as well as non-linear access to the data entry walkthrough. The operator may elect, at any time, to exit the walkthrough and to re-enter the walk-through process at any point. Full completion of the data entry may not be allowed without completing the data entry walk-through process.

The operator may have the ability to fill in any given field with a note or “data not available/requires expert consultation” or “special”.

Some embodiments of the present invention include electronic devices. Electronic devices may interface with the user through a variety of methods known to those skilled in the art. The system can be considered as two pieces—the interface and the system.

In some instances, the interface may be a thin client. A thin client is a term known to those skilled in the art and refers to an interface that provides little or no processing, and simply acts as a data capture mechanism that passes the information to a system on a different electronic device, computer or server. In this embodiment, substantially all the processing, such as the calculation of the insolation map, may be accomplished on an electronic device, computer or server other than the electronic device where data is being input.

In some instances, the interface may be a fat client. A fat client is a term known to those skilled in the art and refers to an interface that captures substantially all or most of the data processing on the same electronic device on which the interface is installed.

The interface may also be a hybrid client. A hybrid client is a term known to those skilled in the art and refers to an interface that provides some but not all of the processing on the same electronic device on which the interface is installed. A hybrid client may provide aspects of both a thin client and a fat client. For example, the insolation map and price comparison may be calculated by the client on the local electronic device, while all the permit forms and financing applications may be created on a separate server.

Some embodiments of the present invention include a device located at the site with data input and output capabilities (e.g., iPhone, Smartphone, e-reader, digital camera, cell phone, laptop, netbook, personal digital assistant (PDA), iPod Touch or custom electronic device designed for this purpose).

Devices located at the site may allow information to be input. Operators may be prompted to input information. The prompts may change in a way that is dependent on prior inputs. Operators may be prompted to input information in response to information provided automatically by the device. In some cases, these devices may be capable of automatically recording data, such as Global Positioning System, or GPS coordinates. The devices may also be capable of recording images, audio or videos.

Operators may record and input an image or images, audio or video. The images may include those required to complete documentation and paperwork—for example, in some municipalities a permit to install solar requires that an image of the electric service be provided to the building inspector along with plan drawings. In some instances, the images may be used by the system to extract structural data.

An interface may be provided to additional data collection devices. For example, laser distance finders may be useful, accurate and precise tools for measuring small roof protrusions. A device might include a laser distance finder that allows a user to input data directly from the laser distance finder to the system. A device might also include a rotating or 3D laser distance finder that can collect information on all roof obstructions at a single point in time, optionally logging the data output with GPS coordinates and direction that the device was facing when collecting the data snapshot.

Collection of structural measurements such as dimensions of and location of objects protruding from the roof may be allowed. In some cases, it may be necessary and/or desirable to have operators take measurements on site as opposed to simply using the information available within the existing 3D model. Operators may be prompted to collect and enter structural measurements.

An operator may determine the best method of collecting required measurements. The operator may, for example, decide to use a tape measure to collect distance measurements, and then enter the data to the system. In some embodiments, structural measurements may be collected by determining the GPS coordinates of various structural details and items of interest. This may be particularly useful, for example, in measuring the size of a lot or where the data collection device has the capability to report its location as GPS coordinates.

In some instances, the operator may be prompted to take a photograph or photographs according to processes known to those skilled in the art. For example, the camera or electronic device may report the GPS coordinates and time at which the photograph was taken. Given a known orientation, the position of the sun in the sky may be calculated, and the heights of nearby objects may be calculated to a reasonable degree of accuracy from the size of the shadows observed in the photograph. The size and shape of the object may be determined using machine vision techniques well-known in the art.

It may be desirable to describe structural components for system design or for permit application purposes. If so, the system may present operators with a representation of common structural embodiments for a particular component. Examples of such components include roof trusses, in which there are several classes of designs that are commonly employed, and roofs, where often specific shapes, such as triangles, trapezoids, and parallelograms are common. An expert system that further prompts the operator for other information about the structural component may also be provided. The initial selection may be cross-checked against the input data to catch any potential errors. Further changes may be suggested to the selection or data entered where there is some mismatch between what is entered and what is expected.

In some instances, the representation may be graphical—a set of images, which may or may not include text that the operator selects. In some instances, there may be an alternate selection that allows an operator to select a type that is not represented. Upon selection of this option, the operator may enter the particular data for the component of interest. The expert system may infer structure from measurements and present options to the operator based on those measurements.

Costs and pricing may be updated in response to site information. The site information may include structural data that changes the system design, and the inclusion of other options such as roof repair or the identification of special situations that require non-standard solutions.

When enough data is collected to trigger a recalculation of the costs and/or pricing per a preset rule, recalculation may occur. Changes may be updated in real time through a user interface and/or the data can trigger other events such as sending an email to the property owner, bank, or a member of the construction staff.

Recalculation may occur with respect to the system design, cost, and/or pricing as each new data point is collected. Changes can be updated in real time or the user can be notified when the degree of change in price or cost has reached a level considered to be significant.

Some embodiments of the invention may prompt the operator to collect homeowner or solar energy system purchaser data useful for completion of financing paperwork. The operator may be prompted to enter data in response to a question or a form field. The operator may be prompted to enter data by taking photographs of various financial documents such as completed tax forms and utility bills, among others. An expert system or a person may extract the desired data from the photographs using methods known to those skilled in the art such as OCR (Optical Character Recognition) or other machine vision methods. The operator may be prompted to enter data in response to a question or form field, and to enter data by photographing certain financial documents.

In order for automated systems to be effective, it is desired that the operators be proficient at providing good input data and effective at collecting necessary data in as efficient a manner as possible. Providing user feedback allows for operators to self-modify inefficient behavior and allows management to identify areas of best practice and areas of weakness among individual operators. Reports may be generated on the effectiveness of the operator. The report may consider the effectiveness of the person inputting the data (e.g., is the data complete). The report may also consider the efficiency of the person inputting data (e.g., the time it takes to complete data input). The report may also consider the value of the initial system design and the degree of matching between original estimate and design/cost following data input.

The operator may be allowed to view or show the progress, scheduling changes, and other outcomes in real time.

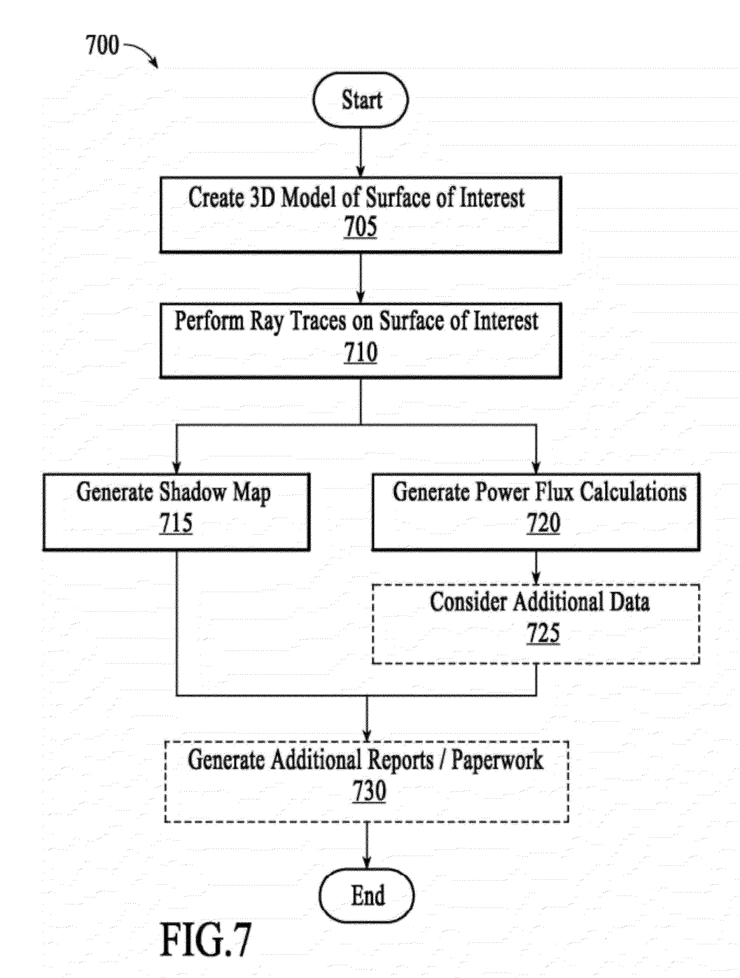

FIG. 7 is a flowchart illustrating an exemplary method according to an embodiment of the present invention. In a step 705, a 3D model of the surface of interest and surrounding area is created. The 3D model may include various shading objects that might block light from contacting the surface of interest.

When the 3D model has been established, ray traces from the sun to the surface of interest may be taken in a step 710. The ray traces may vary in number and timing, so that a ray trace may be taken for any point on the surface of interest for the sun at any time of day or day of the year.

The software system may then generate a shadow map in a step 715. Alternatively, the system may generate in a step 720 power flux calculations. The power flux calculations may be used to design a solar energy system for the surface of interest.

Additional data may be considered in a step 725. Additional data may be from third party sources, additional pictures or ray traces, etc. One item that may be considered as additional data is weather data for the area of the surface of interest.

The shading analysis software in a further step 730 may generate additional reports and paperwork. The software may specifically prepare paperwork that is required by local authorities such as zoning commissions, etc.

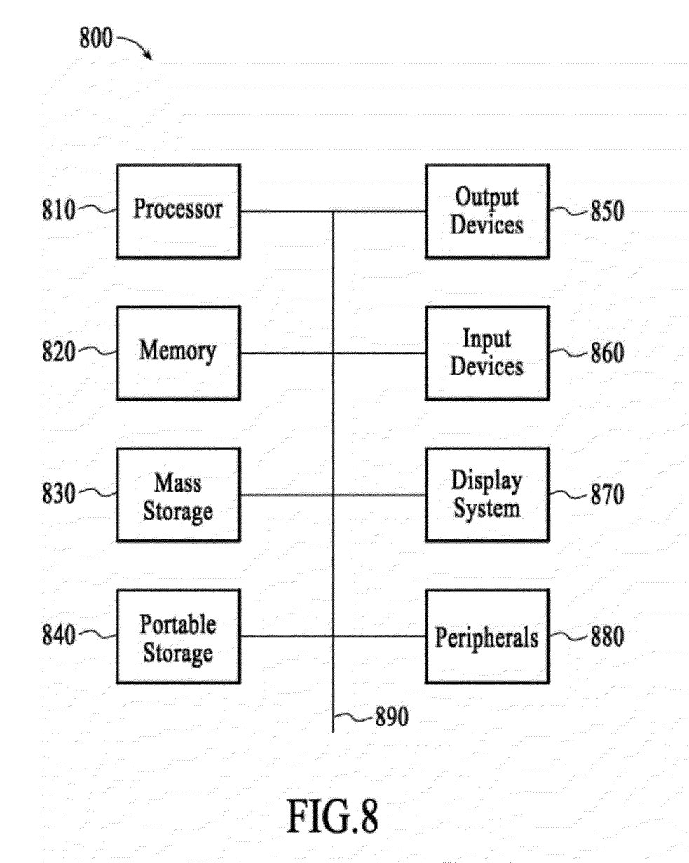

FIG. 8 illustrates an exemplary computing system 800 that may be used to implement an embodiment of the present invention. System 800 of FIG. 8 may be implemented in the context of a general computing system that may support the shading analysis software of the present invention. The computing system 800 of FIG. 8 includes one or more processors 810 and memory 820. Main memory 820 stores, in part, instructions and data for execution by processor 810. Main memory 820 can store the executable code when the system 800 is in operation. The system 800 of FIG. 8 may further include a mass storage device 830, portable storage medium drive(s) 840, output devices 850, user input devices 860, a graphics display 870, and other peripheral devices 880.

The components shown in FIG. 8 are depicted as being connected via a single bus 890. The components may be connected through one or more data transport means. Processor unit 810 and main memory 820 may be connected via a local microprocessor bus, and the mass storage device 830, peripheral device(s) 880, portable storage device 840, and display system 870 may be connected via one or more input/output (I/O) buses.

Mass storage device 830, which may be implemented with a magnetic disk drive or an optical disk drive, may be a non-volatile storage device for storing data and instructions for use by processor unit 810. Mass storage device 830 can store the system software for implementing embodiments of the present invention for purposes of loading that software into main memory 810.

Portable storage device 840 operates in conjunction with a portable non-volatile storage medium, such as a floppy disk, compact disk or Digital video disc, to input and output data and code to and from the computer system 800 of FIG. 8. The system software for implementing embodiments of the present invention may be stored on such a portable medium and input to the computer system 800 via the portable storage device 840.

Input devices 860 provide a portion of a user interface. Input devices 860 may include an alpha-numeric keypad, such as a keyboard, for inputting alpha-numeric and other information, or a pointing device, such as a mouse, a trackball, stylus, or cursor direction keys. Additionally, the system 800 as shown in FIG. 8 includes output devices 850. Suitable output devices may include speakers, printers, network interfaces, monitors, and the like.

Display system 870 may include a liquid crystal display (LCD) or other suitable display device. Display system 870 receives textual and graphical information, and processes the information for output to the display device.

Peripherals 880 may include any type of computer support device to add additional functionality to the computer system. Peripheral device(s) 880 may include a modem or a router.

The components contained in the computer system 800 of FIG. 8 are those typically found in computer systems that may be suitable for use with embodiments of the present invention and are intended to represent a broad category of such computer components that are well known in the art. Thus, the computer system 800 of FIG. 8 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including UNIX, Linux, Windows, Macintosh OS, Palm OS, and other suitable operating systems.

The embodiments described herein are illustrative of the present invention. As these embodiments of the present invention are described with reference to illustrations, various modifications or adaptations of the methods and or specific structures described may become apparent to those skilled in the art in light of the descriptions and illustrations herein. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A system for determining shading on a surface of interest, the system comprising:
a 3D modeling module stored in memory and executable by a processor to create a 3D model of a surface of interest;
a ray trace module stored in memory and executable by the processor to take a ray trace from the sun to a plurality of points on the 3D model of the surface of interest at a plurality of times to represent multiple positions of the sun; and
a shading module stored in memory and executable by the processor to perform a shading calculation of the surface of interest based on the ray trace.

2. The system of claim 1, wherein the shading calculation is used as an input to a power flux calculation module stored in memory and executable by the processor to perform a power flux calculation for the surface of interest.

3. The system of claim 2, wherein the power flux generation calculation is used to design a solar energy system for the surface of interest.

4. The system of claim 3, wherein the solar energy system is designed algorithmically according to a set of design rules.

5. The system of claim 3, wherein one or more keep-out regions are defined for the solar energy system.

6. The system of claim 5, wherein the keep-out regions are defined by manual input.

7. The system of claim 5, wherein the keep-out regions are established by the application of local requirements and legal restrictions.

8. The system of claim 5, wherein the keep-out regions are established by limitations of the components used in the solar energy system.

9. The system of claim 5, wherein the keep-out regions are defined by the calculation of economic payback.

10. A method of calculating the power flux of a surface of interest, the method comprising:
creating a 3D model of a surface of interest, the model being created by a modeling module stored in memory and executable by a processor;
taking a ray trace with a ray trace module stored in memory and executable by the processor, the ray trace being taken from the sun to a plurality of points on the 3D model of the surface of interest at a plurality of times to represent multiple positions of the sun; and
performing a shading calculation with a shading module stored in memory and executable by the processor, the shading calculation being based on the ray trace.

11. The method of claim 10, wherein the shading calculation is used as an input to a power flux calculation module stored in memory and executable by the processor to perform a power flux calculation for the surface of interest.

12. The method of claim 11, wherein the power flux generation calculation is used to design a solar energy system for the surface of interest.

13. The method of claim 12, wherein the solar energy system is designed algorithmically according to a set of design rules.

14. The method of claim 12, wherein one or more keep-out regions are defined for the solar energy system.

15. The method of claim 14, wherein the keep-out regions are defined by manual input.

16. The method of claim 14, wherein the keep-out regions are established by the application of local requirements and legal restrictions.

17. The method of claim 14, wherein the keep-out regions are established by limitations of the components used in the solar energy method.

18. The method of claim 14, wherein the keep-out regions are defined by the calculation of economic payback.

19. A computer-readable storage medium having embedded thereon a program, the program executable by a processor to perform a method of calculating the power flux of a surface of interest, the method comprising:
creating a 3D model of a surface of interest, the model being created by a modeling module stored in memory and executable by a processor;
taking a ray trace with a ray trace module stored in memory and executable by the processor, the ray trace being taken from the sun to a plurality of points on the 3D model of the surface of interest at a plurality of times to represent multiple positions of the sun; and
performing a shading calculation with a shading module stored in memory and executable by the processor, the shading calculation being based on the ray trace.

20. The computer-readable storage medium of claim 19, wherein the shading calculation is used as an input to a power flux calculation module stored in memory and executable by the processor to perform a power flux calculation for the surface of interest.

21. The computer-readable storage medium of claim 20, wherein the power flux generation calculation is used to design a solar energy system for the surface of interest.
